(19) United States
(12) Patent Application Publication
(10) Pub. No.: US 2026/0266209 A1
(43) Pub. Date: Sep. 10, 2026

(54) AQUEOUS COMPOSITION HAVING IMPROVED PROPERTIES FOR THE TREATMENT OF EXHAUST GASES

(71) Applicant: TOTALENERGIES ONETECH, Courbevoie (FR)

(72) Inventor: Veronica Castillo, Solaize (FR)

(21) Appl. No.: 18/993,788

(22) PCT Filed: Jul. 19, 2023
(86) PCT No.: PCT/FR2023/051125

§ 371 Date: Oct. 22, 2025

(30) Foreign Application Priority Data
Jul. 19, 2022 (FR) FR2207392

(51) Int. Cl. F01N 3/20; B01D 53/94; F01N 3/08

(52) U.S. Cl. CPC F01N 3/2066; B01D 53/9409; F01N 3/0842; B01D 2251/2067; B01D 2258/01; B01D 2259/4566; F01N 2610/02

(57) ABSTRACT

The present invention relates to a paraffin-free aqueous composition comprising:
at least one nitrogen oxide NOx reducing agent and/or at least one precursor of such an agent, and
at least one additive selected from polyoxyethylenated monoesters of fatty acids including 12 to 22 carbon atoms and sorbitan, at a total content of 10 to 1,500 ppm by weight relative to the total weight of the composition.

Another object of the present invention is the use of such a composition for the treatment of exhaust gases at the outlet of internal combustion engines, as well as a method for treating exhaust gases of an internal combustion engine implementing this composition.

The present invention relates to a composition for the treatment of exhaust gases at the outlet of on-board or stationary heat engines, whether the engines are engines for heavy vehicles such as heavy-goods vehicles, transport vehicles, so-called “Off Road” vehicles such as agricultural machinery, boats, or engines for light and/or utility vehicles or engines for stationary industrial applications. It also relates to the use of such a composition in any device for treating exhaust gases, as well as a method for treating exhaust gases implementing this composition.

### PRIOR ART

European standards related to pollution emitted by heat engines, in particular those fed with Diesel fuels, in particular the standards applicable to heavy-goods vehicles, have led the manufacturers of engines to place exhaust gas after-treatment systems. These systems include the SCR (Selective Catalytic Reduction), EGR (Exhaust Gas Recirculation), DOC (Diesel oxidation Catalyst), DPF (Diesel particulate filter) and SCRFR (an SCR combined with a DPF) technologies. These different after-treatment systems may be installed alone or in combination to the extent that they do not always act on the same pollutants present in the exhaust gases.

In order to comply with standards, in particular European standards (the standards Euro IV et seq, for heavy-goods vehicles and Euro 6 for light vehicles), most European manufacturers of motor vehicles have opted for SCR after-treatment at the exhaust of their engines. This after-treatment acts exclusively on the reduction of nitrogen oxides present in the gases. Another advantage of this technique is that, by optimised settings of the engine, it allows for a substantial reduction in fuel consumption, in particular in comparison with other after-treatment systems like NOx traps.

The SCR after-treatment consists in reducing the nitrogen oxides NO and NO₂ (commonly called NOx) on a catalytic device which allows bringing them into contact with a reducing agent. This device contains a catalyst comprising a support generally based on zeolites exchanged with iron or copper. This catalyst promotes the reduction of NOx into nitrogen, by reaction with the reducing agent. For example, a conventional reducing agent is ammonia (NH₃). In order to introduce gaseous ammonia into the exhaust gas treatment system, it is known to produce it directly in the pipe conveying these gases to the SCR system by vaporising an aqueous solution of a precursor of this reducing agent such as, for example, urea. The urea solution, injected at an average exhaust temperature generally from 150 to 400° C., releases ammonia thanks to successive thermolysis and hydrolysis reactions. Other ammonia precursor compounds may be used under similar conditions. An injector is usually used to introduce the urea aqueous solution into the pipe conveying the exhaust gases to the SCR catalyst, upstream of the latter. A mixer or blender, installed between this injector and the SCR catalyst, may be used in order to improve the vaporisation of the urea aqueous solution spray in the exhaust gas stream. An example of a mixer is described in document SAE 2015-01-1020 (“Advanced Close Coupled SCR Compact Mixer Architecture”, Michelin J. et al.).

Two conventional, yet non-limiting, examples of the configuration of the SCR after-treatment line are described hereinafter. The first one, so-called the “underfloor” or “sub-floor” configuration, consists in placing the SCR after-treatment device downstream of the engine, under the floor of the vehicle (generally at more than 50 cm at 1 m from the outlet of the combustion chamber). It has the advantage of being able to install the after-treatment device in an area where a lot of space is available and thus place it under geometry conditions more favourable to vaporisation of the urea aqueous solution. Another so-called “close-coupled” configuration consists in placing the SCR after-treatment device immediately proximate to the engine (generally at less than 50 cm from the outlet of the combustion chamber). In comparison with the so-called “underfloor” configuration, this configuration has the advantage of benefiting from higher temperatures in the SCR catalyst, improving priming and efficiency thereof. On the other hand, its drawback is that the available space is smaller than in the “underfloor” configuration, which implies that the urea aqueous solution injector is placed closer to the mixer and the SCR catalyst. This configuration could lead to less vaporisation of the urea aqueous solution. The documents SAE 2014-01-1522 (“Control of a Combined SCR on Filter and Under-Floor SCR System for Low Emission Passenger Cars”, Balloon J. et al.) and SAE 2015-01-0994 (“Next Generation All in One Close-Coupled Urea-SCR System”, Kojima H. et al.), or WO2014060987A1 describe these two configuration types.

In some configurations of installation of the SCR device and of the injection of an ammonia precursor, in particular in the case of urea injection, the manufacturers have noticed the apparition of deposits in the exhaust pipes located between the injector and the SCR device. These deposits may be large enough to cause a partial, and even complete, clogging of the exhaust duct related to the back pressure at the exhaust and thus create losses in power of the engine. With a constant injection configuration, the amount of formed deposits is larger at low temperatures than at high temperatures. These deposits, according to the analyses that have been made in SAE 2016-01-2327 technical publication, are of variable nature according to the temperature at which they were formed. Thus, at temperatures lower than 250-300° C., they consist predominantly of crystallised urea, and consist predominantly of cyanuric acid beyond 300° C. Cyanuric acid could sublimate and produce gaseous ammonia again. Nonetheless, this reaction can occur only at a very high temperature, higher than 450° C. Such a temperature is hardly reached at this location in exhaust pipes.

In particular, it has been noticed that these deposits were present in pipes having elbows because of the lack of space in the vehicle, and when the distance separating the urea injection and the first elbows is too short, like in the previously-described “close-coupled” configurations. The formulated assumption is that, in this configuration type, part of the urea drops does not have time to vaporise and completely decompose into gaseous ammonia. The urea drops deposit over the wall of the pipe which is at a temperature that is too low to enable complete decomposition into gaseous ammonia, and they decompose only partially forming cyanuric acid deposits sticking to the wall. Moreover, it has also been noticed that, depending on the configuration of the SCR line and the temperature, The urea was able to crystallise in the line, with the consequence of a clogging of the line (cf. document SAE 2017-26-0132-“A Study on the Factors Affecting the Formation of Urea Crystals and Its Mitigation for SCR After-Treatment Systems”, Jain A. et al.).

Application WO2008/125745 describes an aqueous solution comprising a compound likely to release gaseous ammonia above 200° C. and at least one polyfunctional additive, the HEB of which varies from 7 to 17 to limit the formation of the deposits based on cyanuric acid in an exhaust gas after-treatment device, in particular of the SCR type. In particular, the implemented polyfunctional additives are ethers of polyalkoxylated fatty alcohols and esters of polyalkoxylated fatty alcohols.

Application EP2337625 describes a mixture of surfactants allowing reducing the diameter of the droplets of an urea aqueous solution, and thus promoting vaporisation thereof and the transformation of urea into gaseous ammonia in an SCR system. The proposed solution consists of a mixture of polyalkoxylated fatty alcohols, with controlled degrees of alkoxylation.

Patent application EP2488283 describes additives for an urea solution, of the particular polyalkoxylated fatty alcohols type. These additives are also intended to promote a reduction in the formation of deposits resulting from the decomposition of urea in SCR systems.

Patent U.S. Pat. No. 5,453,257 teaches the reduction of the nitrogen oxide content in the combustion effluents of a carbonaceous fuel by introduction into said effluents of an emulsion of a nitrogen oxide reducing compound and of a hydrocarbon compound having a boiling point lower than that of the nitrogen oxide reducing agent.

In addition, it has been noted that the ammonia precursor aqueous solutions containing surfactants tend to foam. In particular, this foaming occurs during transport and handling of the solution, for example when it is unloaded into the storage cisterns, then when the composition is introduced from a storage cistern into the tank of a vehicle, which complicates the operation of filling the tank and could cause overflow thereof. The current use of guns during the dispense of the composition also promotes foaming thereof. Furthermore, foaming of the composition when it occurs at the time of injection thereof into the gas treatment system of the vehicle could result in the introduction of a more or less large amount of air into said system. This phenomenon disturbs control of the amount of injected solution and affects the efficiency of the treatment system.

One solution to this problem consists in adding one or more anti-foaming agent(s) to the aqueous solution. Yet, such additives often have an efficiency that decreases during the time of storage of the composition before use thereof, especially when the composition is stored at relatively high temperatures, higher than 30° C. or 35 or 40° C. Under such storage conditions, the composition generally cannot be retained more than a few months (on average 5 months), which proves to be very constraining.

Hence, there is a need to make it possible to formulate compositions for the treatment of exhaust gases in the form of aqueous solutions based on a NOx reducing agent, for example ammonia, or a precursor of such a reducing agent, like urea, which have optimised properties. This composition is expected to be capable of avoiding or reducing deposits during use on an SCR line, while reducing as much as possible, and even while avoiding, foaming phenomena. This composition is also expected to be stable over time, i.e. it preserves its properties over long periods of storage, including at high temperature.

The Applicant has discovered that these objectives were achieved by adding to the aqueous composition at least one particular additive selected from specific polyoxyethylenated esters of fatty acids and sorbitan as defined hereinafter.

Thus, an object of the present invention is an aqueous composition comprising:
(1) at least one nitrogen oxide NOx reducing agent and/or at least one precursor of such an agent, and
(2) at least one additive selected from polyoxyethylenated monoesters of fatty acids including from 12 to 22 carbon atoms and sorbitan, at a total content from 10 to 1,500 ppm by weight relative to the total weight of the composition.

This composition does not contain paraffins.

Another object of the present invention is a use of such a composition for the treatment of exhaust gases at the outlet of on-board or stationary internal combustion engines, more particularly for the treatment of exhaust gases in a device for selective catalytic reduction of nitrogen oxides.

In particular, the engine may be selected from Diesel engines, spark ignition engines (including gasoline engines and NGV or natural gas engines for vehicles), and mixed-fuel engines, in particular gas oil-gas engines. Preferably, the engine is a Diesel engine.

The present invention applies to any type of engine capable of emitting nitrogen oxides, including on-board engines and stationary engines. The invention applies, inter alia, to marine engines, to engines of heavy-goods vehicles, transport vehicles, work machinery or agricultural machinery such as, for example, tractors, to light vehicle and utility vehicle engines, as well as engines used in stationary industrial applications.

By “device for selective catalytic reduction of nitrogen oxides”, it should be understood a device known per se as SCR device, standing for “Selective Catalytic Reduction” in English. Such a device comprises a Selective Catalytic Reduction catalyst (also so-called SCR catalyst).

The invention also relates to a method for treating exhaust gases originating from an internal combustion engine, preferably a Diesel engine, equipped with a device for selective catalytic reduction of nitrogen oxides, this method being characterised in that it includes at least one step of introducing a composition as defined hereinabove into the pipe that conveys the exhaust gases from the outlet of the engine towards said selective catalytic reduction device.

Next, by SCR exhaust line or SCR line, it should be understood, in a manner known per se, the pipe that conveys the exhaust gases from the outlet of an engine towards a selective catalytic reduction device (SCR device).

The composition according to the invention has numerous advantages: it can be used in the same way and in the same equipment as the solutions of the prior art. It is at least as effective, and even more effective, than the solutions of the prior art, in particular the solutions based on urea in the reduction or prevention of the formation of deposits in SCR systems, in particular in the so-called “close-coupled” configurations. It does not, or barely, cause foaming during handling, use, transfer and/or transport thereof, for example during operations of transferring into or filling containers such as cans, vehicle tanks, storage cisterns or transport cisterns. In particular, it allows avoiding overflows during filling of the storage tank of a vehicle. It also allows filling the storage cisterns and the tanks of the vehicles more quickly, and in the latter case while limiting jerks of the filling guns.

This composition also enables an accurate control of the amount of composition injected, and in particular allows avoiding the errors related to the failure of the sensors by the foam.

The composition according to the invention is stable in storage. It also has antifoam performances maintained over time, in particular over periods ranging up to one year, over a wide range of storage temperatures, ranging from 5° C. to 40° C.

Other objects, features, aspects and advantages of the invention will appear more clearly upon reading the description and the examples that follow.

Next, and unless indicated otherwise, the bounds of a range of values are included in this range, in particular in the expressions “comprised between” and “ranging from . . . to . . . ”.

Moreover, the expressions “at least one” and “at least” used in the present description are respectively equivalent to the expressions “one or more” and “greater than or equal to”.

Finally, in a manner known per se, by CN compound or group, it should be understood a compound or a group containing N carbon atoms in its chemical structure.

### DETAILED DESCRIPTION

The Reducing Agent and/or the Precursor of Such an Agent

The composition used in the invention comprises at least one nitrogen oxide reducing agent and/or at least one precursor of a nitrogen oxide reducing agent (1).

By “nitrogen oxide reducing agent”, it should be understood a compound capable of reducing at least partially, otherwise completely, the nitrogen oxides (also referred to as NOx to designate the compounds NO and NO₂) into nitrogen, under conventional conditions of operation of an SCR line, i.e. in the presence of an SCR catalyst and at a temperature ranging from 150 to 400° C. Among the NOx reducing agents, mention may particularly be made of ammonia (NH₃).

By “precursor of a NOx reducing agent”, it should be understood a compound capable of releasing a NOx reducing agent under the effect of temperature and/or by catalytic reaction.

Among ammonia precursors, mention may be made of urea which, by successive thermolysis and hydrolysis reactions, produces ammonia according to a well-known process. The SCR exhaust line may comprise, upstream of the SCR catalytic system, a catalyst whose function is to transform a precursor of a NOx reducing agent into a NOx reducing agent, in particular into gaseous ammonia.

Preferably, the reducing agent or the precursor of the reducing agent is selected from the list consisting of urea, ammonia, formamide, ammonium salts, in particular ammonium formate, ammonium carbamate, and guanidine salts, in particular guanidinium formate; and preferably from the list consisting of urea and ammonia.

According to a preferred embodiment, urea, which is a reducing agent precursor, is used. Indeed, urea has the advantage of being stable, non-volatile, non-explosive and non-flammable. It can be transported without any risk, stored and handled by an operator without any specific training.

In this embodiment, the composition has a urea content ranging preferably from 25% to 42% by weight, more preferably from 30% to 40% by weight, still more preferably from 31 to 35% by weight and better still from 32% to 33% by weight, relative to the total weight of the composition. In a particularly preferable manner, the composition contains urea at a content of 32.5+0.7% by weight, in compliance with the specifications of the standard ISO 22241-1.

According to a particularly preferred variant of this embodiment, the aqueous solution according to the invention is prepared from the product commercialised under the brand AdBlue®, which is an aqueous solution of urea at 32.5±0.7% by weight. The term AdBlue® is used in the present description to indifferently designate the commercial products well-known under the following names: AdBlue®, DEF, AUS32, ARLA32. By “extension”, it should be understood all urea-based products in aqueous solution, including the product commercialised under the name AUS40 which corresponds to an aqueous solution of urea at about 40% by weight and is intended essentially for marine engines.

Nonetheless, it is also within the scope of the present invention to use aqueous compositions containing urea with a concentration higher than 32.5%, which can be diluted afterwards just before implementation. This variant allows achieving savings on the transportation of these urea-based compositions.

### The Polyoxyethylenated Monoesters of Fatty Acids and Sorbitan

The composition according to the invention contains at least one additive (2) selected from polyoxyethylenated monoesters of fatty acids including from 12 to 22 carbon atoms and sorbitan.

Advantageously, these esters are selected from those having an HLB ranging from 12 to 17, and more preferably from 12.5 to 16.5. By HLB, it should be understood, in a manner known per se, the hydrophilic/lipophilic balance of said compound, determined according to the method defined by Griffin.

Preferably, the fatty acid(s) of said monoesters (2) are linear, saturated or monounsaturated mono-acids. As indicated before, these fatty acids comprise from 12 to 22 carbon atoms. More preferably, they comprise from 12 to 20 carbon atoms, and still more preferably from 12 to 18 carbon atoms. Lauric, myristic, palmitic and oleic acids are preferred. Lauric acid and oleic acid are particularly preferred.

Advantageously, said monoesters (2) comprise an average number of oxyethylene units (referred to as OE units, of formula —CH2—CH2—O—) comprised in the range from 10 to 30, and preferably from 15 to 25, and more preferably 20.

Particularly preferred monoesters (2) are selected from polyoxyethylenated sorbitan monolaurate with 20 OE, polyoxyethylenated sorbitan monooleate with 20 OE and mixtures thereof. Polyoxyethylenated sorbitan monolaurate with 20 OE is particularly preferred.

These compounds are commonly available on the market.

The monoester(s) (2) are present at a total content from 10 to 1,500 ppm by weight, preferably from 50 to 1,000 ppm by weight and better still from 200 to 800 ppm by weight, relative to the total weight of the composition.

### The Anti-Foam Additives

According to a preferred embodiment, the composition according to the invention further comprises one or more anti-foam additive(s), preferably selected from grafted polydimethylsiloxane polymers.

Preferably, the anti-foam additive(s) is/are selected from copolymers comprising a polydimethylsiloxane backbone with an average number of dimethylsiloxane units comprised in the range from 150 to 300, grafted with polyoxyalkylene chains.

Hence, these copolymers are grafted polymers, with a polydimethylsiloxane backbone and polyoxyalkylene side chains (or grafts) grafted onto the backbone.

The backbone of these polymers consists a of polydimethylsiloxane chain (also commonly referred to as PDMS), i.e. a chain of formula —[Si(CH₃)₂—O]ₙ—, with n a number comprised in the range from 150 to 300.

Preferably, the polydimethylsiloxane backbone comprises an average number of dimethylsiloxane units comprised in the range from 180 to 250. This corresponds to a value of the number n comprised in the range from 180 to 250.

Advantageously, the polyoxyalkylene chains correspond to the formula —(RO)ₘ— with R denoting one or more branched or linear C₁ to C₄, preferably C₂ or C₃, alkylene group(s), and m is a number comprised in the range from 10 to 55.

Preferably, the average number m of oxyalkylene units is in comprised the range from 20 to 50, more preferably from 30 to 50.

Also preferably, R denotes one or more C₂ and/or C₃ alkylene group(s), and more preferably the polyoxyalkylene chains are selected from polyoxyethylene (EO) of formula —(CH2—CH2—O)ₘ—, poly oxypropylene (PO) of formula —(CH₂—CH(CH₂)—O)ₘ—, and chains formed of oxyethylene units and of oxypropylene units (EO/PO).

According to a particularly preferred embodiment, the polyoxyalkylene chains are formed of oxyethylene (EO) units and of oxypropylene (PO) units. Preferably, the ratio of the average number of EO units to the average number of PO units is comprised in the range from 0.2 to 2, preferably from 0.3 to 1.3. Preferably, these chains are formed of polyoxyethylene blocks and polyoxypropylene blocks.

The grafting rate of the copolymers (i.e. the number-average proportion of dimethylsiloxane units bearing a polyoxyalkylene side chain) is advantageously in the range from 0.5% to 5%, preferably from 1% to 2%.

Unless explicitly stated otherwise, all of the averages mentioned in the present description are number-averages.

According to a preferred embodiment, the copolymers forming the anti-foam additive are crosslinked. Such crosslinking confers a three-dimensional structure thereon.

Advantageously, the anti-foam additive(s) may be present at a total content ranging from 1 to 200 ppm by weight, preferably from 2 to 100 ppm by weight, more preferably from 3 to 50 ppm by weight, better from 5 to 25 ppm by weight and better still from 10 to 15 ppm by weight, relative to the total weight of the composition.

The above-described copolymers are known per se, and commercially available.

In commercial products, these copolymers may in particular be in a diluted form, in a mixture containing them.

In this case, the content of copolymer(s) of such mixtures is generally comprised in the range from 10% to 80% by weight, preferably from 20% to 60% by weight, more preferably from 30% to 50% by weight and better still from 35% to 45% by weight.

Thus, according to one embodiment, the anti-foam additive(s) is/are used as a mixture with an inorganic oxide, such as for example solid hydrophobic silica.

According to another embodiment, the anti-foam additive(s) is/are used as a mixture with one or more emulsifying agent(s), which may in particular be selected from polyoxyalkylene polymers as described hereinbefore, and more preferably EO/PO copolymers. In general, these polymers originate from the synthesis of the copolymer and correspond to a proportion of polyoxyalkylene chains not grafted onto the polydimethylsiloxane backbone.

According to a particularly preferred embodiment, the anti-foam additive(s) is/are used as a mixture with an inorganic oxide and an emulsifying agent, such as in particular with hydrophobic silica and one or more polyoxyalkylene polymer(s) as described hereinbefore.

The commercial products containing the anti-foam additive(s) may be in the form of a solid product, in particular anhydrous (i.e. free of water), or in the form of a solution in a solvent which may consist of water or an organic solvent.

### Additional Surfactants

The composition according to the invention may further comprise one or more additional surfactant(s), different from the polyoxyethylenated monoesters of fatty acids including from 12 to 22 carbon atoms and sorbitan described hereinbefore. In particular, these surfactants may be selected from water-soluble ionic, non-ionic, or amphoteric surfactants.

The ionic surfactants may be selected from cationic surfactants and anionic surfactants, and preferably from cationic surfactants. In general, these comprise a cationic or ionisable nitrogen group in a cationic form. In particular, they may be selected from linear alkylamines and alkylammonium, linear diamines, aromatic or saturated heterocycles containing one or more nitrogen atom(s), imidazole-type cyclic compounds, etheramines and etheramides, oxyamines and ethoxyamines, considered separately or as a mixture.

In particular, the amphoteric surfactants may be selected from amino acids and their imide or amide derivatives, considered separately or as a mixture.

Preferably, the non-ionic surfactants are selected from the following compounds:
a) hydrocarbyl and mono- or polyalkylene glycol ethers,
b) hydrocarbyl and polyol ethers,
c) esters of fatty acid and mono- or polyalkylene glycol,
d) esters of fatty acid and mono- or polyglycerol,
e) and mixtures of these compounds.

By “hydrocarbyl”, it should be understood a group selected from an alkyl, an alkenyl, an alkynyl, an aryl, an aryl-alkyl or “aralkyl” group; advantageously the hydrocarbyl is an C₁-C₅₀ group.

By “Cᵢ-Cⱼ alkyl”, it should be understood a saturated, linear, branched or cyclic hydrocarbon chain comprising from i to j carbon atoms.

By “Cₓ-C_{y}” alkenyl, it should be understood a linear, branched or cyclic hydrocarbon chain including at least one carbon-carbon double bond, and comprising from x to y carbon atoms.

By “Cₓ-C_{y}” alkynyl, it should be understood a linear, branched or cyclic hydrocarbon chain including at least one carbon-carbon triple bond, and comprising from x to y carbon atoms.

By “Cₓ-C_{y} aryl”, it should be understood a functional group which derives from an aromatic hydrocarbon compound comprising from x to y carbon atoms. This functional group may be monocyclic or polycyclic. For illustration, a C₆-C₁₈ aryl may be phenyl, naphthalene, anthracene, phenanthrene and tetracene.

By “Cₓ-C_{y}” aralkyl, it should be understood an aromatic hydrocarbon compound, preferably monocyclic, substituted by at least one linear or branched alkyl chain and wherein the total number of carbon atoms of the aromatic ring and its substituents ranges from x to y carbon atoms. For illustration, a C₇-C₁₈ aralkyl may be selected from the group formed by benzyl, tolyl and xylyl.

In the context of the present invention, by “polyol”, it should be understood an oxygenated hydrocarbon compound comprising at least two alcohol functions. The polyols may possibly contain one or more other oxygenated function(s), like for example an acetal function, an ether bridge, an ester group.

By fatty acid, reference is made, in a manner known per se, to a carboxylic acid comprising a C₄-C₃₀, preferably C₈-C₃₀, linear or branched alkyl or alkenyl chain.

### a) Hydrocarbyl and Mono- or Polyalkylene Glycol Ethers

The hydrocarbyl and mono- or polyalkylene glycol ethers may be mono-ethers or diethers, depending on whether the polyalkylene glycol chain is substituted on one or two end(s) by a hydrocarbyl group.

Advantageously, the hydrocarbyl and mono- or polyalkylene glycol ethers are selected from those comprising a C₁-C₅₀ hydrocarbyl group and with 1 to 60 alkylene glycol units.

More preferably, the hydrocarbyl and mono- or polyalkylene glycol ethers are selected from the following compounds:
mono- or poly-alkoxylated hydrocarbyl mono-ethers of formula (I): R—(Y)ₙ—OH;
mono- or poly-alkoxylated hydrocarbyl di-ethers of formula (II): R—(Y)ₘ—OR′;
mono- or poly-alkoxylated hydrocarbyl di-ethers of formula (III): HO—(Y)ₙ—R″—(Y′)ₘ—OH;
and mixtures of these compounds.

In the formulae (I) to (III) hereinbefore R and R′ independently represent C₃-C₄₀ alkyl or alkenyl or alkynyl or aryl or aralkyl groups; R″ represents a C₃-C₄₀ diyl alkane or diyl alkene or diyl alkyne group or aryl di-radical or aralkyl di-radical.

To facilitate the description, the same designation of alkyl or alkenyl or alkynyl or aryl or aralkyl radical is subsequently used for a mono radical (R, R′) and for a di-radical (R″).

In the formulae (I) to (III) hereinbefore, Y and Y′ are groups selected independently of one another from the following groups: —(O—CH₂—CH₂)—, —(O—CH(CH₃)—CH₂)— and —(O—CH₂—CH₂—CH₂)—.

In the same compound of formula (I), (II) or (III), the Y, respectively Y′, groups, may be all identical or may be different. For example, —(Y)ₙ— may represent a copolymer with ethylene oxide and propylene oxide units, like for example a block copolymer.

Preferably, in the formulae (I) to (III), all of the Y, respectively Y′, groups are identical.

Still more preferably, in the formulae (I) to (III), all of the Y, respectively Y′, groups are ethylene oxide of formula —(O—CH₂—CH₂)—.

In the formulae (I) to (III) hereinbefore, n, m represent the degree of alkoxylation of the molecule, and denote, independently of one another, an integer ranging from 1 to 60, advantageously from 1 to 30, better still from 1 to 20. More preferably, n and m vary from 3 to 15, better still from 5 to 12.

Advantageously, in formula (III), the groups Y and Y′ represent —(O—CH₂—CH₂)— and n=m.

According to a first embodiment, in the formulae (I), (II) and (III), advantageously R, R′ and R″ are selected from linear or branched, preferably linear, alkyl and alkenyl groups.

Even more advantageously, R, R′ and R″ are selected from C₅-C₃₂, more preferably C₈-C₃₀, alkyl groups.

The compounds of formula (I) may be particularly selected from polyalkoxylated linear or branched fatty alcohols comprising from 4 to 30 carbon atoms, preferably from 8 to 30 carbon atoms, better still from 10 to 24 carbon atoms; and from 5 to 12 ethylene oxide and/or propylene oxide, preferably ethylene oxide, units.

Among the compounds of formula (I) commercially available, mention may be made of the products of the Marlipal® range and those of the Surfaline® range.

According to a second embodiment, in the formulae (I), (II) and (III), R, R′ and R″ are selected from C₄-C₅₀ alkynyls.

Advantageously, this embodiment relates to the formula (III), wherein R″ is a C₄-C₅₀ alkynyl.

For example, according to this embodiment, the compound of formula (III) may be represented by the formula (IV) hereinbelow:

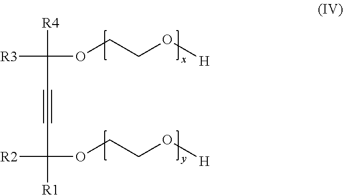

wherein R1, R2, R3, R4 represent, independently of one another, H or a C₁-C₂₀ alkyl group and x and y represent, independently of one another, an integer ranging from 1 to 60, preferably from 1 to 30.

An example of a commercial product corresponding to this formula is Surfynol 104® commercialised by the company Air Products.

According to a third embodiment, in the formulae (I), (II) and (III), R, R′ and R″ are selected from aralkyl groups comprising from 9 to 30 carbon atoms.

Preferably, this embodiment relates to the formula (I), wherein R represents a group selected from aralkyls comprising from 9 to 30 carbon atoms.

More preferably, R is selected from para-alkylphenyls comprising a C₁-C₂₄, more preferably C₃-C₂₀, and better still C₅-C₁₈, alkyl group.

According to this embodiment, the compound of formula (I) may be represented by the formula (V) hereinbelow:

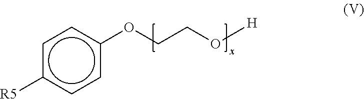

wherein R5 represents a C₁-C₂₄, preferably C₃-C₂₀, better still C₅-C₁₈, alkyl group, and x represents an integer ranging from 1 to 50, preferably from 1 to 30.

An example of such a compound is the product Dynol 800® commercialised by the company Air Products, which corresponds to the following formula:

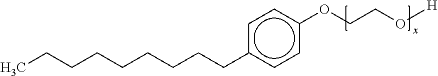

Advantageously, the compounds of formula (I) may be mixtures obtained by reaction of R—OH alcohols with n ethylene oxide and/or propylene oxide units. n represents the number of moles of alkylene oxide which has been reacted with one mole of R—OH alcohol.

Advantageously, the compounds of formula (II) may be mixtures obtained by reaction of R—OH alcohol compounds with m units of ethylene oxide and/or propylene oxide followed by an etherification reaction with an alcohol compound R—OH. m represents the number of moles of alkylene oxide which has been reacted with one mole of R—OH alcohol.

Advantageously, the compounds of formula (III) may be obtained by reaction of a diol HO—R″—OH with (n+m) ethylene oxide and/or propylene oxide units. Advantageously, in the formula (III): n=m. (m+n) represents the number of moles of alkylene oxide which has been reacted with one mole of diol HO—R″—OH.

In general, the compounds of formula (I), (H) and (III) are in the form of mixtures of compounds having varied degrees of alkoxylation.

### b) Ethers of Hydrocarbyl and Polyols

Advantageously, the ethers of hydrocarbyl and polyols are selected from ethers derived from an alcohol including a C₁-C₅₀, preferably C₃-C₄₀, more advantageously C₅-C₃₂, better still C₈-C₃₀, alkyl or alkenyl group and a polyol.

The polyols to which reference is herein made are different from mono- and polyalkylene glycols.

Advantageously, according to a first variant, the polyol is selected from the compounds belonging to the carbohydrate family and their oligomers. In particular, the polyol is selected from cyclic carbohydrate compounds, like, for example, glucopyranose oligomers. In particular, the invention relates to hydrocarbyl ethers and cyclic polyglucoside.

Among the hydrocarbyl and cyclic polyglucoside ethers, mention may be made of alkyl polyglucosides such as the product commercialised under the name Triton CG650® by the company Dow Chemical.

Advantageously, according to a second variant, the polyol is glycerol or a glycerol oligomer, for example an oligomer comprising 2 to 30 glycerol units, preferably from 3 to 20 glycerol units.

### c) Esters of Fatty Acid and Mono- or Polyalkylene Glycol

The esters of fatty acids and of mono- or polyalkylene glycol are molecules resulting from the condensation of at least one fatty acid with 1 to 60 alkylene glycol units, preferably 1 to 50 alkylene glycol units. Advantageously, they are derived from the reaction of a fatty acid with 1 to 50 ethylene glycol units.

In general, the fatty acids are molecules comprising an alkyl or alkenyl chain, carrying at its end a carboxylic acid function, and comprising 4 to 30 carbon atoms, preferably 8 to 30 carbon atoms, more advantageously 8 to 24 carbon atoms.

The fatty acid group may be a single molecule or a mixture corresponding to the fatty acid distribution of an animal or vegetable oil.

Among the fatty acids, mention may be made, in a non-limiting manner, of a saturated fatty acid such as n-caproic acid, caprylic acid, n-capric acid, lauric acid, myristic acid, palmitic acid, stearic acid, isostearic acid, arachidic acid or an unsaturated fatty acid such as palmitoleic acid, oleic acid, linoleic acid, linolenic acid, arachidonic acid or docosahexaenoic acid.

Advantageously, the esters of fatty acids and mono- or polyalkylene glycol comprise from 3 to 50, better still from 5 to 40 alkylene oxide units. Better still, the esters of fatty acids and mono- or polyalkylene glycol comprise from 3 to 50, advantageously from 5 to 40, ethylene oxide units.

As examples of esters of fatty acids and polyalkylene glycols, mention may be made of the product DUB S PEG 30S (PEG-30 stearate) commercialised by the company Stearinerie Dubois.

### d) Fatty Acid and Mono- or Polyglycerol Esters

The fatty acid and mono- or polyglycerol esters are molecules resulting from the condensation of at least one fatty acid with 1 to 60 alkylene glycol units, preferably 1 to 50 glycerol units.

The fatty acids are identical to those described in point c) hereinabove.

Advantageously, the fatty acid and mono- or polyglycerol esters comprise from 3 to 50, better still from 5 to 40, glycerol units.

As examples of fatty acid and polyglycerol esters, mention may be made of the product Polyaldo 10-1-0 KFG® (polyglycerol laurate) commercialised by the company LONZA.

According to a preferred embodiment, the surfactant(s) are selected from non-ionic surfactants. Quite particularly, it is preferred to use one or more surfactant(s) selected from ethers if hydrocarbyl and mono- or polyalkylene glycol, and more preferably from monoethers of mono- or poly-alkoxylated hydrocarbyl of formula (I):
R—(Y)ₙ—OH, wherein:
R represents a C₃-C₄₀, preferably C₈-C₃₀, still more preferably C₁₀-C₂₄, alkyl, alkenyl or alkynyl group;
Y is selected from: —(O—CH₂—CH₂)—, —(O—CH(CH₃)—CH₂)— and —(O—CH₂—CH₂—CH₂)—; and preferably Y denotes —(O—CH₂—CH₂)—;
n is an integer ranging from 1 to 60, preferably from 1 to 30, more preferably from 1 to 20, better from 3 to 15, better still from 5 to 12.

The total content of the additional surfactant(s), when these are present, may range from 5 to 10,000 ppm by weight, preferably from 50 to 5,000 ppm by weight, more preferably from 100 to 2,500 ppm by weight, and better still from 200 to 1,000 ppm by weight, relative to the total weight of the composition.

### Other Constituents

Optionally, the aqueous composition may contain one or more other compound(s), different from the nitrogen oxide reducing agents—and their precursors, monoesters of fatty acids and sorbitan, anti-foam additives and additional surfactants described hereinbefore.

Thus, the composition may comprise, in a non-limiting manner, one or more organic fluid(s) preferably water-miscible such as, for example, alcohols, polyols, and/or one or more metal compound(s).

According to a preferred embodiment, the composition according to the invention does not comprise any metal compound(s).

By “metal compound”, it should be understood any organic or inorganic compounds comprising one or more metal(s). These compounds may be ionic or non-ionic. In particular, the composition does not contain organometallic compounds or inorganic metal compounds, whether ionic or non-ionic.

Examples of ionic compounds excluded according to this embodiment include in particular the compounds comprising one or more metal(s) selected from the following metals: Fe, Cu, Ni, Co, Zn, Mn, Mg, Ti, V, Sr, Pt, Ce, Ca, Li, Na, and Nb.

By “containing no metal compounds”, it should be understood that the composition does not contain such compounds intentionally added. Thus, if such compounds are present in the composition, they are considered as impurities and the content of each metal element provided by said metal compound(s) is lower than 1 ppm by weight, in particular lower than 0.5 ppm by weight, relative to the total weight of the composition.

The composition according to the invention is devoid of paraffins. By paraffins, it should be understood alkanes of formula CₙH₂ₙ₊₂, with n being an integer ranging from 2 to 50, preferably from 6 to 40, more preferably from 18 to 35. By “containing no paraffins”, it should be understood that the composition does not contain intentionally added paraffins. Thus, if such paraffins are present in the composition, they are considered as impurities and their content is lower than 80 ppm by weight, preferably lower than 50 ppm by weight, better lower than 20 ppm by weight and better still lower than 10 ppm by weight, relative to the total weight of the composition.

According to a preferred embodiment, the composition according to the invention does not comprise a hydrocarbon liquid phase. In particular, the composition does not comprise a water-insoluble hydrocarbon liquid phase, including in a dispersed form (oil-in-water emulsion).

By “liquid phase”, it should be understood a phase which is in the liquid state at 25° C. and at atmospheric pressure (1.013×105 Pa).

By “insoluble in water”, it should be understood a phase whose solubility in water at 25° C. and at atmospheric pressure (1.013×105 Pa) is lower than 2% by weight, and preferably lower than 1% by weight, still more preferably less than 0.5% by weight.

In particular, the composition according to the invention is not in the form of an emulsion. By “emulsion”, it should be understood, in a manner known per se, a composition comprising at least two liquid phases, one of the phases being dispersed in the form of droplets in the other phase.

### The Composition and Embodiments Thereof

The composition used in the present invention is an aqueous composition, i.e. its main component is water. Preferably, the water content of the composition is comprised in the range from 50% to 90% by weight, preferably from 60% to 80% by weight, and better still from 65% to 70% by weight, relative to the total weight of the composition.

The composition may be prepared in a usual manner by mixing its constituents, preferably at room temperature, typically in a temperature range generally from 10 to 60° C.

According to a preferred embodiment, the aqueous composition is prepared from a pre-formulated aqueous solution of urea, like for example a commercial composition known as AdBlue® comprising 32.5% by weight of urea.

A first embodiment consists in adding the polyoxyethylenated monoester(s) of fatty acids and sorbitan (2) and the optional anti-foam additive(s) to this urea pre-formulated aqueous solution, in an amount required to reach the contents defined hereinbefore.

A second embodiment consists in adding to this urea pre-formulated aqueous solution an urea concentrated aqueous composition with additives. According to this embodiment, the urea concentrated aqueous composition with additives comprises the polyoxyethylenated monoester(s) of fatty acids and sorbitan (2) and the optional anti-foam additive(s) at contents much higher than that of the final aqueous composition introduced into the SCR line, in an urea aqueous solution, preferably at a content of 32.5% by weight of urea. Mixing of the two compositions in a suitable ratio to obtain the desired final contents is carried out just before the injection into the SCR line.

The same embodiments may be implemented from a pre-formulated aqueous solution of a precursor other than urea.

### The Use

The aqueous composition according to the invention is used to treat the exhaust gases of an internal combustion engine in a device for selective catalytic reduction of nitrogen oxides or SCR device.

To this end, it is introduced into the SCR exhaust line, downstream of the engine and upstream of the SCR device. This introduction is typically carried out by pumping the composition from one or more tank(s) and injecting it by means of one or more injector(s), which allow spraying the composition into the flow of the exhaust gases. These devices are known per se.

The use according to the invention also allows preventing or reducing deposits in the pipe that conveys the exhaust gases from the outlet of an internal combustion engine towards said selective catalytic reduction device.

These deposits are typically deposits of nitrogen compounds, containing the reducing agent(s) of nitrogen oxides and/or their precursor(s), and/or decomposition products of said precursors. Quite particularly, the invention allows preventing and/or reducing deposits, in particular urea and/or cyanuric acid deposits, and more particularly cyanuric acid deposits in the SCR exhaust pipe.

As indicated hereinbefore, the invention allows reducing or avoiding these deposits regardless of the conformation of the SCR line. The invention is particularly, yet without limitation, suitable for the so-called “close-coupled” and “underfloor” SCR exhaust lines, as described hereinbefore.

In particular, the invention allows reducing such deposits, while avoiding the foaming phenomena of the composition.

As set out hereinbefore, the composition injected into the SCR line is pumped from one or more conventional storage tank(s), known per se.

According to a first variant, all of the components of the composition according to the invention, in particular the nitrogen oxide reducing agent(s) and/or their precursor(s) (1), the monoester(s) of polyoxyethylene sorbitan fatty acids (2) and the optional anti-foam additive(s) are formulated in the same aqueous composition at the desired contents, and this composition is introduced into one single tank.

According to a second variant, a first intermediate aqueous composition comprising the nitrogen oxide reducing agent(s) and/or their precursor(s) (1) is formulated, at the desired contents in the final composition resulting from mixing of the two intermediate compositions. This first intermediate composition is introduced into a first tank. A second concentrated intermediate aqueous composition with additives is also represented, comprising the nitrogen oxide reducing agent(s) and/or their precursor(s) (1) at the desired contents in the final composition resulting from mixing of the two intermediate compositions, as well as the monoester(s) of polyoxyethylene sorbitan fatty acids (2) and the optional anti-foam additive(s) in a more concentrated content than the desired content in said final composition.

This second composition is introduced into a second tank, distinct from the first tank. The two tanks feed the same injection system, enabling mixing of the two intermediate compositions. A vehicle comprising two tanks for implementing such a variant is described in particular in EP2541012.

### The Process

The process (or method) according to the invention allows treating the exhaust gases originating from an internal combustion engine, preferably a Diesel engine, equipped with an SCR system.

This process comprises a step of introducing an aqueous composition as described hereinabove into the pipe conveying the exhaust gases at the outlet of an engine towards a device for selective catalytic reduction of nitrogen oxides. This introduction is typically carried out by pumping the composition from one or more tank(s) and by injecting it into said pipe by means of one or more injector(s), as described hereinabove.

The examples hereinafter are given for illustration of the invention and cannot be interpreted in a manner limiting the scope thereof.

### Examples

### Tested Compositions:

A commercial AdBlue® aqueous solution containing 32.5% by weight of urea in accordance with the standard ISO 22241 was used as the base composition. This base composition is referred to as C0.

The following additives were added:
A1: polyoxyethylene sorbitan monolaurate with 20 OE;
A2: polyoxyethylene sorbitan monooleate with 20 EO:
A3: crosslinked copolymer comprising a PDMS backbone with an average number of dimethylsiloxane units of 200, grafted by chains formed of polyoxyethylene blocks and polyoxypropylene blocks having an average number of OE units=16 and a number means of OP units=30; Grafting rate of 1.57%; this copolymer is in the form of a mixture further containing hydrophobic silica and EO/OP copolymers, containing 40% by weight of said copolymer.

C₁ to C₄ additive compositions were prepared, by adding to the composition C0 the additives defined hereinbefore, with the contents detailed in Table 1 hereinbelow (contents indicated in ppm by weight of active material, relative to the total weight of the composition).

TABLE 1

| Additive | C1 | C2 | C3 | C4 |
|---|---|---|---|---|
| A1 | 500 | | 500 | |
| A2 | | 500 | | 500 |
| A3 | | | 5 | 5 |

### Test for Determining the Amount of Deposits:

The capacity of reductions in deposits of the C₁ to C₄ additive compositions in comparison with the reference composition C0 has been evaluated using the ECTO-Lab™ system (“Exhaust Composition Transient Operation Laboratory™”). These tests have been carried out in the laboratories of the South West Research Institute (SwRI, San Antonio, Texas, USA). The system further has an oxidation catalyst device and a particulate filter (so-called “DOC/DPF” device, standing for “Diesel Oxidation Catalyst/Diesel Particle Filter”) upstream of the injector to remove soot originating from the exhaust gas. A Bosch Denoxtronix 2.2 injector has been used. A static mixer is incorporated at 5 cm after the injector. At the end of the test, the amounts by weight of deposits in the mixer and in the localised elbow after the mixer are quantified.

The conditions of the test are as follows:
Pressure of the injector: 8 bar;
Injected composition flow rate: 920 g/h;
Air flow rate: 660 kg/h;
Duration of the test: 1 h;
Temperature of the exhaust gas at the injector: 180-215° C.

The obtained results are detailed in Table 2 hereinbelow.

TABLE 2

| Composition | % of deposit reduction in comparison with C0 |
|---|---|
| C1 (invention) | 26 |
| C2 (invention) | 29 |
| C3 (invention) | 23 |
| C4 (invention) | 25 |

These results show that the compositions according to the invention allow obtaining a substantial reduction in the deposits generated by crystallisation and/or poor decomposition of the urea in the SCR system.

### Foaming Tests:

The foaming level of these different compositions has been determined by means of a DFA 100 foaming bench commercialised by the company Krüss.

In this system, foaming is generated by supplying ascending air, introduced throughout a sintered glass located at the bottom of a column containing the composition to be tested. The device enables direct reading of the volume of foam formed over time.

The measurements have been performed at room temperature (25° C.), each time after an air injection duration of 30 s, at a flow rate of 0.3 L/min. The volume of composition introduced into the column for each test is 40 ml. The volumes of foam have been measured 60 s after the beginning of the test.

Each composition has been tested immediately after preparation thereof.

The obtained results are detailed in Table 3 hereinbelow.

TABLE 3

| Composition | Foam volume | |
|---|---|---|
| C1 (invention) | 148 | ml |
| C2 (invention) | 158 | ml |
| C3 (invention) | 6 | ml |
| C4 (invention) | 9 | ml |

The results hereinabove show that compositions C₃ and C₄ also allow reducing foaming substantially.

1. An aqueous composition comprising:
(1) at least one nitrogen oxide reducing agent and/or at least one precursor of such an agent, and
(2) at least one additive selected from polyoxyethylenated monoesters of fatty acids comprising from 12 to 22 carbon atoms and of sorbitan, at a total content from 10 to 1,500 ppm by weight relative to the total weight of the composition,
this composition containing no paraffins.

2. The composition according to the preceding claim, characterised in that the reducing agent or the precursor of the reducing agent (1) is selected from the list consisting of urea, ammonia, formamide, ammonium salts, and guanidine salts; and preferably from the list consisting of urea and ammonia; and more preferably the precursor of the reducing agent is urea.

3. The composition according to any one of the preceding claims, characterised in that the composition contains urea, at a content ranging from 25% to 42% by weight, preferably from 30% to 40% by weight, more preferably from 31 to 35% by weight and better still from 32% to 33% by weight, relative to the total weight of the composition; and still more preferably 32.5±0.7% by weight, relative to the total weight of the composition.

4. The composition according to any one of the preceding claims, characterised in that the fatty acid(s) of said monoesters (2) comprise from 12 to 20 carbon atoms, preferably from 12 to 18 carbon atoms.

5. The composition according to any one of the preceding claims, characterised in that said monoesters (2) comprise an average number of oxyethylene units (OE units) comprised in the range from 10 to 30, preferably from 15 to 25, and more preferably of 20.

6. The composition according to the preceding claim, characterised in that the monoester(s) (2) are selected from polyoxyethylene sorbitan monolaurate with 20 OE, polyoxyethylene sorbitan monooleate with 20 OE and mixtures thereof, and preferably the ester (2) is polyoxyethylene sorbitan monolaurate with 20 OE.

7. The composition according to any one of the preceding claims, characterised in that the monoester(s) (2) is/are present at a total content from 50 to 1,000 ppm by weight, preferably from 200 to 800 ppm by weight, relative to the total weight of the composition.

8. The composition according to any one of the preceding claims, characterised in that it further comprises one or more anti-foam additive(s), preferably selected from grafted polydimethylsiloxane polymers, and more preferably from copolymers comprising a polydimethylsiloxane backbone with an average number of dimethylsiloxane units comprised in the range from 150 to 300, grafted by polyoxyalkylene chains.

9. The composition according to the preceding claim, characterised in that the polydimethylsiloxane backbone of said copolymers comprises an average number of dimethylsiloxane units in the range from 180 to 250.

10. The composition according to any one of claims 8 and 9, characterised in that the polyoxyalkylene chains of said copolymers correspond to the formula —(RO)ₘ— with R denoting one or more C₁ to C₄ alkylene group(s) and m a number in the range from 10 to 55, preferably the polyoxyalkylene chains are selected from polyoxyethylenes (EO), polyoxypropylenes (PO) and chains formed of oxyethylene units and oxypropylene units (EO/PO), and still more preferably from chains formed of oxyethylene (EO) units and oxypropylene (PO) units with a ratio of the average number of EO units to the average number of PO units preferably in the range from 0.2 to 2, more preferably from 0.3 to 1.3.

11. The composition according to any one of claims 8 to 10, characterised in that said copolymer is crosslinked.

12. The composition according to any one of claims 8 to 11, characterised in that the anti-foam additive(s) are present at a total content ranging from 1 to 200 ppm by weight, preferably from 2 to 100 ppm by weight, more preferably from 3 to 50 ppm by weight, better from 5 to 25 ppm by weight and better still from 10 to 15 ppm by weight, relative to the total weight of the composition.

13. The composition according to any one of claims 8 to 11, characterised in that it does not contain any metal compound(s).

14. Use of a composition as defined in any one of the preceding claims for the treatment of exhaust gases from on-board or stationary internal combustion engines.

15. Use of a composition as defined in any one of claims 1 to 13 for preventing or reducing deposits in the pipe which conveys the exhaust gases from the outlet of an internal combustion engine towards a device for selective catalytic reduction of nitrogen oxides.

16. A method for treating exhaust gases originating from an internal combustion engine equipped with a device for selective catalytic reduction of nitrogen oxides, characterised in that it includes at least one step of introducing a composition as defined in any one of claims 1 to 13 into the pipe which conveys the exhaust gases from the outlet of the engine to said selective catalytic reduction device.
